(19) United States
(12) Patent Application Publication
(10) Pub. No.: US 2012/0299726 A1
(43) Pub. Date: Nov. 29, 2012

(54) Proximity sensor

(76) Inventor: Michael Anthony Shifflett, Glen Arm, MD (US)

(21) Appl. No.: 13/506,152

(22) Filed: Jun. 21, 2012

Related U.S. Application Data
(60) Provisional application No. 61/516,113, filed on Mar. 30, 2011.

(51) Int. Cl. G08B 1/08

(52) U.S. Cl. 340/539.32

(57) ABSTRACT

Wireless proximity devices function in a group designed for the purpose related but not limited to tracking, locating and identifying devices that are active in the group or missing from the group using “in the air” wireless technologies.

### REFERENCE TO RELATED APPLICATIONS

This application claims an invention which was disclosed in Provisional Application Number U.S. 61/516,113 filed Mar. 30, 2011, entitled “Proximity Sensors”. The benefit under 35 USC §119(e) of the United States provisional application is hereby claimed, and the aforementioned application is hereby incorporated herein by reference.

### FIELD OF THE INVENTION

The present invention relates to tracking devices, and more particularly, to functions that allows multiple “TDS” (tracking device software) units to work together keeping track of the items needing to be tracked and located.

### BACKGROUND

In September 2006-October 2008 the initial idea and concept was developed after reading a Southwest Airlines article in In-Flight magazine stating that over 12,000 laptop computers were misplaced, left or forgotten in LAX airport every week. $30 Billion worth of mobile phones lost or misplaced last year . . . . So then how much is it with Laptops, IPods, cameras, pocketbooks, keys . . . . Proximity Sensors is based on networking units to create methods and applications enabling units with features similar to:

### Monitoring Tracking Locate Update Manage

The concept prototype was designed and produced with limited capabilities in 2010 by Davison Inventions.

Leveraging standard materials, methods, technologies and application logic currently in production with an existing large market. Example: GPS/WiFi/Free In the Air . . . this invention will be able to reach local, national and global markets through tracking items in various settings:

1. Personal items

2. Children

3. Travel

4. Business Items/Asset Tracking/Location Security

5. Implement as software using embedded existing technology and components

6. Work with manufacturers to integrate “TDS” chip into existing product lines

7. Government/Asset Tracking/Item Location Security/Prison Inmate Monitoring

### SUMMARY OF APPLICATION

### Application Example

### General Use (As shown in FIG. 1)

A) Customer purchases 4 TDS units to track or locate the following:
   1. Laptop computer
   2. Mobile phone/PDA
   3. Car Keys
   4. Wallet
B) Customer needs to activate the 4 TDS units by touching the 4 TDS units to each other.
   *Note that if customer purchased all 4 TDS units as a package, then the 4 units have already been activated prior to shipping from factory.
C) Customer attaches TDS unit to each of the 4 items noted in “A” above.
D) Now all 4 items with the attached TDS unit will alert customer anytime the item is out of the allowable range 15-90 feet (selectable ranges, default is 30 ft.) of the entire group.
E) Customer purchased digital camera and wants to add tracking and locating capabilities.
F) Customer purchases a single TDS unit to add to the existing group of 4 items currently activated.
G) Customer activates the single TDS unit by touching the TDS unit to any of the existing active TDS units.
H) Customer attaches the single TDS unit to the digital camera.
I) Now the customer has 5 items in the TDS group to track and locate:
   1. Laptop Computer
   2. Mobile Phone/PDA
   3. Car Keys
   4. Wallet
   5. Digital Camera
Note—If any of the 5 items with the TDS units attached is 30 feet apart then the TDS units will alert customer.
J) Customer decided not to track and locate item #1, Laptop computer. To deactivate the TDS on the laptop the customer can do the following:
   1. Push and hold the OFF button for 5 seconds.
   2. Do nothing and the unit will remove itself after it has no communication with group for 5 minutes.

### BRIEF DESCRIPTION OF THE DRAWING

FIG. 1 shows Proximity Sensor Architecture-Communications

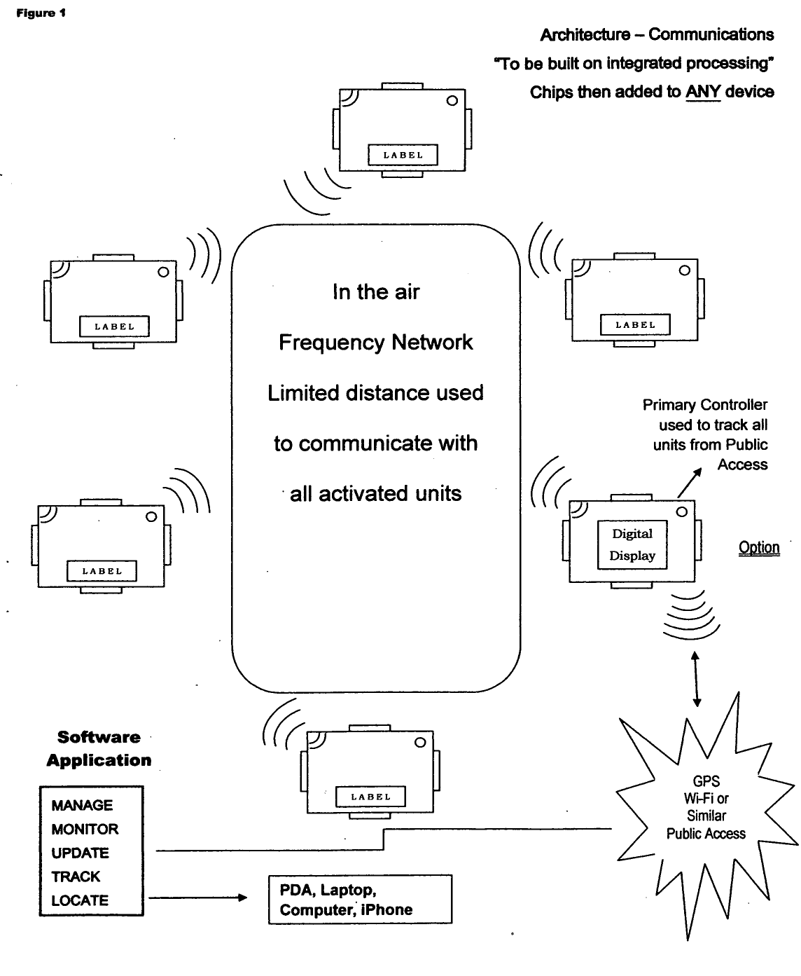

FIG. 2 shows Networked Proximity Sensor Operations

FIG. 3 shows Networked Proximity Sensor Architecture-Power Options

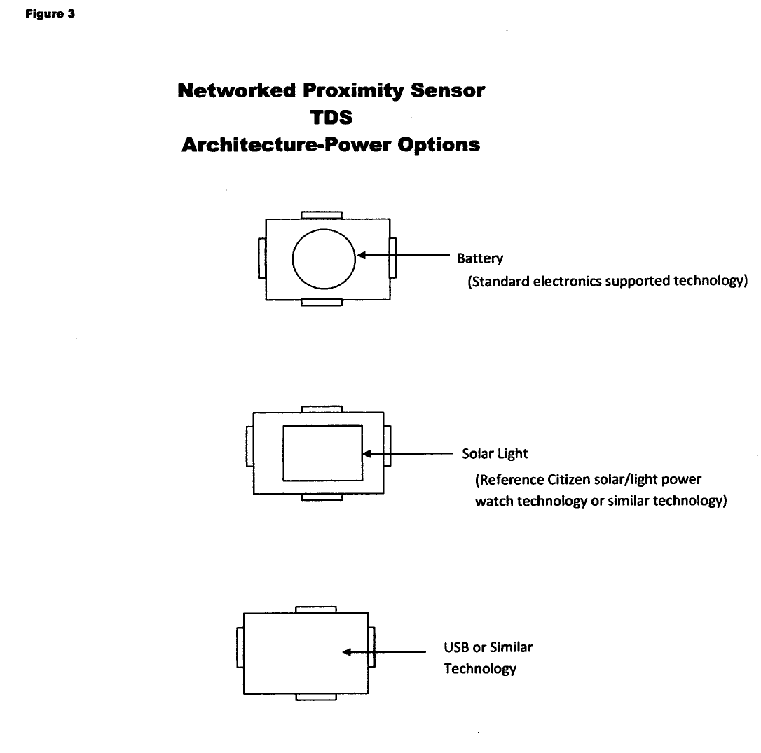

### DETAILED DESCRIPTION OF THE INVENTION

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

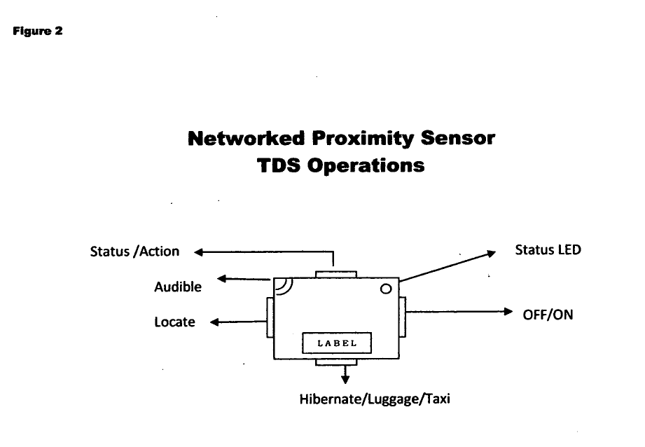

Network Proximity Sensor TDS Operations (As Shown in FIG. 2)

Button Locate
Press and hold 5 seconds to locate luggage
Press 1 time for TDS 1
Press 2 times for TDS 2
Press 3 times for TDS 3
Press 4 times for TDS 4
Press 5 times for TDS 5

STATUS LED
Flash green slow/fast=far/close
Audible slow/fast=far/close

Button Status/Action
Press 1 time-Status
   Status LED
      Green/ON Red/OFF Amber/HIBERNATE
Press 2 times-Firmware in sync G/yes R/N A/issues
Press 3 times-Hibernate/Luggage Tracking ON/OFF G/ON R/OFF
Press 4 times
Press 5 times—Update Firmware

Status LED
Green/Update complete
Red/Updating in progress
Amber/Update complete with issues

Button OFF/ON
Press and hold 5 seconds to turn off/on
Press 2 times to initiate activation
All units off—press and hold LOCATE & OFF/ON button until red light on.

Button HIBERNATE/LUGGAGE/TAXI
Press and hold 5 seconds to turn on G/ON R/OFF
Press 2 times to turn OFF with auto activate R/OFF
Press 1 time to activate Taxi Mode

### Application Example

### Specialized Use

### Application

### Track Luggage

A) Customer purchases a “TDS” travel package that has 2-4 units designed to activate with functions specific to monitor and tracking luggage.
B) Customer activates the travel units by touching the units to an existing activated group unit. This will add the travel units selected to the monitor and tracking group.
C) Customer attaches TDS units that have been activated to each piece of luggage.
D) The travel units are now active and assigned in a monitor and tracking group but need to be enabled to start the luggage specific mode.
E) “Typical” process would be to enable the Hibernate/Luggage mode when actually checking in the luggage at the terminal. Terminal=Airport/Cruise/Bus . . . .
F) Please note that when any TDS unit is activated all units communicate and this allows the customer to activate features from any unit.
G) To enable all the luggage units at one time press the Hibernate/Luggage button and hold for 5 seconds.
H) All of the luggage units will flash and produce an audible alert thus confirming the successful change of mode.
I) At this point the luggage units are in Hibernate mode and waiting for the Locate message to be sent. Once received the luggage units will send out a return proximity message.
J) The unit that activated the Locate function for the luggage will receive the proximity message.
K) At this point the customer will know how many of the luggage units are in close proximity.
   Example: Customer is settled in his/her seat on the plane and has located all luggage placed under the plane in the luggage storage area.
L) If a luggage unit has not responded, the customer can inform the flight attendant.

### TDS “Proximity Sensor” Activate & Deactivate Process

Methods to Activate “TDS” units into an active group or to begin a group:
1. To begin a group
   Touch any two units together until either the audio alerts “Activated New Group” or the LED's stay solid green for 5 seconds.
2. Add units into existing group
   Touch unit to existing activated unit
      Or
   Press the OFF/ON button twice
      Audible & LED will indicate status

Methods to Deactivate “TDS” units:
Same process as above with audible and LED indication status.

### Taxi Mode Operation

1. Press 1 time to activate the close proximity mode=3-5 feet distance.
2. Press 2 times to deactivate and place units into standard mode.

What is claimed is:

1. A method of Tracking, Locating and Controlling wireless devices:
using all current or future wireless communications methods and technology
creating the ability for any applicable device to communicate with other applicable devices
creating the ability for hardware design, development and manufacture using current or future methods, technology and architecture
creating the ability for software application design, development and manufacture using current or future software methods, technology and architecture

2. A method according to claim 1 wherein settings comprises:
activating and deactivating from the system or group of devices working together to track, locate or control
changing type of use or function related to distance and personality of the device
Add, delete, update modify the features and functionality that provides the services for the device

3. A method according to claim 1:
wherein the devices that are hardware and software applications or software only added to an existing device for the purpose of supporting claim 1

4. A method according to claim 1:
wherein the devices support wireless distances determined by the limitations of the specific type of methods, technology and architecture at the time of design and manufacturing

5. A method according to claim 1:
wherein the devices support access security based on current and future methods, technology and architecture

6. A method according to claim 1:
wherein the devices that are manufactured will be designed, developed and manufactured using current or future methods, technology and architecture

7. A method according to claim 1:
wherein the premises that support claim 1 can be in any location that has the ability to support or allow wireless communications using current or future methods, technology and architecture

8. A method according to claim 1:
wherein applications that are executed on the devices are available to be executed on the devices from a central or distributed location providing features and functionality

9. A system according to claim 1:
wherein instructions given to devices from a central location, distributed location or local to the device group, allow the devices to communicate and meet the application requirements and claim 1

10. A system according to claim 9:
wherein the devices function or emulate a location specific to tracking, locating and monitoring based on proximity of the other devices using wireless communication technologies working together as a group in a point-to-point, point-to-multipoint or complete mesh network of devices to deliver the applications and claim 1

11. A system according to claim 9:
wherein the devices will maintain a network or group of proximity devices that communicate and control each device through an election process that will create a primary controller
wherein the elected primary controller is not available the remaining devices will elect a new primary controller

12. A system according to claim 9:
wherein the proximity devices will function as a group and maintain the ability to track and locate any item the devices are responsible, either by physically connecting to the item or whereby adding hardware or software to an existing device. e.g. computer or camera.
